(19) United States
(12) Patent Application Publication
(10) Pub. No.: US 2015/0303002 A1
(43) Pub. Date: Oct. 22, 2015

(54) CAPACITOR AND MANUFACTURING METHOD THEREOF

(71) Applicant: Electronics and Telecommunications Research Institute, Daejeon (KR)

(72) Inventors: Ho-Gyeong YUN, Seoul (KR); In-Kyu YOU, Gongju-si (KR); Yong Suk YANG, Daejeon (KR); Sunghoon HONG, Daejeon (KR)

(73) Assignee: Electronics and Telecommunications Research Institute, Daejeon (KR)

(21) Appl. No.: 14/467,506

(22) Filed: Aug. 25, 2014

(30) Foreign Application Priority Data
Apr. 22, 2014 (KR) 10-2014-0048126

(51) Int. Cl. H01G 11/52; H01G 11/24; H01G 11/84

(52) U.S. Cl. CPC H01G 11/52; H01G 11/84; H01G 11/24

(57) ABSTRACT

Provided is a method for manufacturing a capacitor. The method includes forming a separator on a first electrode, forming a second electrode on the separator, and filling pores with an electrolyte, wherein the separator includes patterns and pores defined by the patterns, and the patterns formed by directly applying an ink to the first electrode through a printing process.

### CROSS-REFERENCE TO RELATED APPLICATIONS

This U.S. non-provisional patent application claims priority under 35 U.S.C. §119 of Korean Patent Application No. 10-2014-0048126, filed on Apr. 22, 2014, the entire contents of which are hereby incorporated by reference.

### BACKGROUND OF THE INVENTION

The present invention disclosed herein relates to a capacitor and a manufacturing method thereof, and more particularly, to a capacitor manufactured through a further simplified process and a manufacturing method thereof.

A capacitor is a device capable of storing electricity, which is also called a storage battery. The capacitor is used for a circuit board of a computer, a mobile phone, or the like, as well as home appliances such as a refrigerator, a washing machine, and a television. The capacitor basically has a structure in which two electrodes are opposed and an insulator is inserted therebetween. The capacitor is classified into three types, e.g. an electrostatic capacitor, an electrolytic capacitor, and an electrochemical capacitor.

Generally, the electrochemical capacitor is used for an application which needs an explosive output and a quick charge. Accordingly, the electrochemical capacitor is required to reduce its internal ionic resistance and increase a capacitance per unit volume. One of influential parameters to the capacitance of the electrochemical capacitor is a separator. Typically, the separator is made of a porous thin film and inserted between two electrodes. However, when the separator is inserted between the electrodes, it is difficult to design and manufacture a porous structure optimized for a charge transfer. Furthermore, the separator has lower interfacial energy at a surface thereof than that of an electrolytic solvent, and thus has poor wetting property with the electrolyte. Therefore, ion migration through the separator is not sufficient, and implementing the performance of the electrochemical capacitor has a limitation.

### SUMMARY OF THE INVENTION

The present invention provides methods for manufacturing a capacitor including a separator manufactured through a further simplified process.

The present invention also provides a capacitor including a separator with further improved performance.

The object of the present invention is not limited to the aforesaid, but other objects not described herein will be clearly understood by those skilled in the art from descriptions below.

Embodiments of the present invention provide a method for manufacturing a capacitor including forming a separator on a first electrode, forming a second electrode on the separator, and an electrolyte between the first electrode and the second electrode, wherein the separator includes patterns and the pores defined by the patterns and the patterns are formed by directly applying an ink to the first electrode through a printing process.

In some embodiments, the printing process may include ink-jet printing, screen printing, reverse offset printing, doctor blade printing, roll-to-roll printing, spray printing, or gravure printing.

In other embodiments, the patterns may be arranged to be separated from each other in a first direction and a second direction crossing the first direction.

In still other embodiments, the patterns may include first patterns and second patterns, wherein the first patterns extend in the first direction and are arranged in the second direction crossing the first direction, and the second patterns extend in the second direction and are arranged in the first direction such that the second patterns cross the first patterns.

In even other embodiments, the first patterns and the second patterns may be formed at the same time.

In yet other embodiments, the patterns may be selectively formed on a whole or part of a surface of the first electrode.

In further embodiments, the separator may include cellulose, polyolefin, polyethylene, polypropylene, polyamide, polyethylene terephthalate (PET), or polytetrafluoroethylene (PTFE).

In still further embodiments, the electrolyte may fill a whole or the part of the pores

In other embodiments of the present invention, a capacitor includes: a first electrode; a separator including patterns which are arranged on the first electrode to be separated from each other in a first direction and a second direction crossing the first direction; a second electrode disposed on the separator; and an electrolyte filled between the first electrode and the second electrode.

In some embodiments, the patterns may extend in the first direction and the second direction.

In other embodiments, the separator may further include pores defined by the patterns, and the electrolyte may fill a whole or part of the pores.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a method for manufacturing a capacitor according to an embodiment of the present invention;

FIG. 2 is a cross sectional view illustrating a capacitor according to an embodiment of the present invention;

FIGS. 3A and 3B are plan views illustrating a separator according to an embodiment of the present invention;

FIG. 4 is a cross-sectional view illustrating an ink-jet printing method according to an embodiment of the present invention;

FIG. 5 is a perspective view illustrating a roll-to-roll printing method according to an embodiment of the present invention; and

FIG. 6 is a cross-sectional view illustrating a rotary type screen printing method according to an embodiment of the present invention.

### DETAILED DESCRIPTION OF PREFERRED EMBODIMENTS

Advantages and features of the present invention, and implementation methods thereof will be clarified through following embodiments described with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout.

In the following description, the technical terms are used only for explain a specific exemplary embodiment while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes. For example, an etched region having a right angle illustrated in the drawings may have a round shape or a shape having a predetermined curvature. Areas exemplified in the drawings have general properties, and are used to illustrate a specific shape of a semiconductor package region. Thus, this should not be construed as limited to the scope of the present invention.

Hereinafter, it will be described about an exemplary embodiment of the present invention in conjunction with the accompanying drawings.

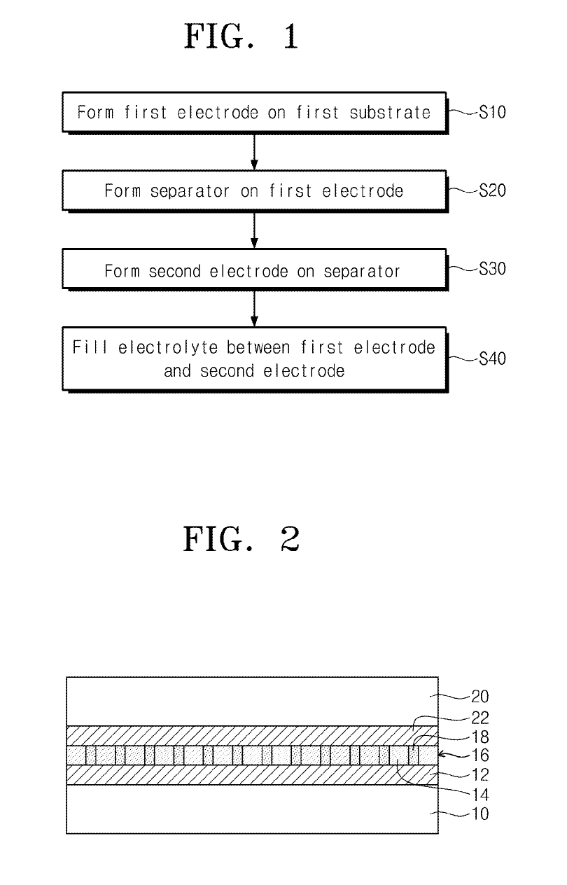

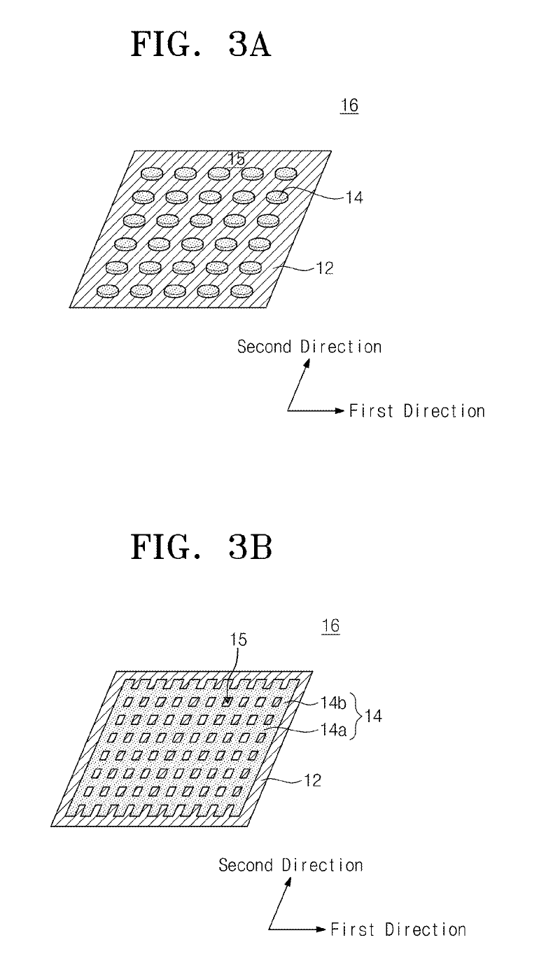

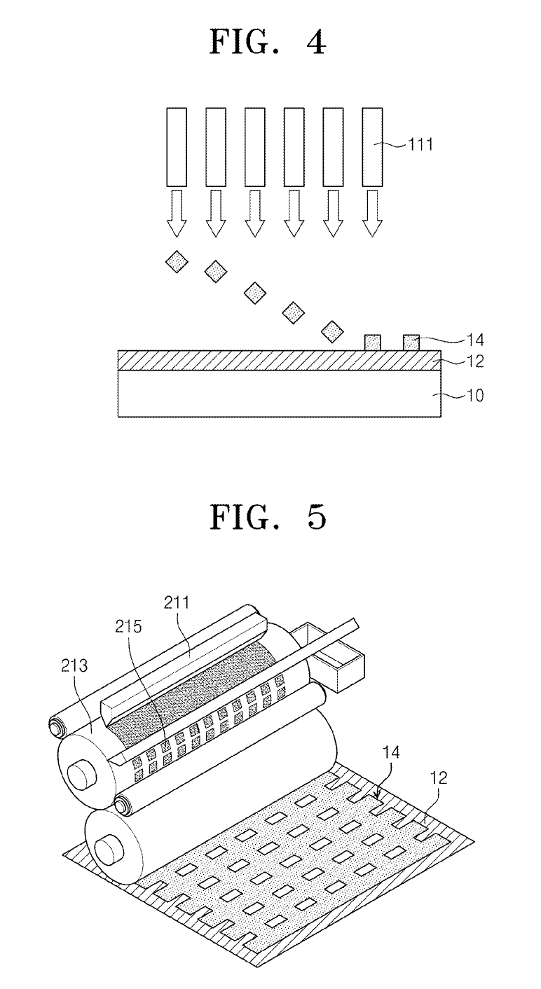

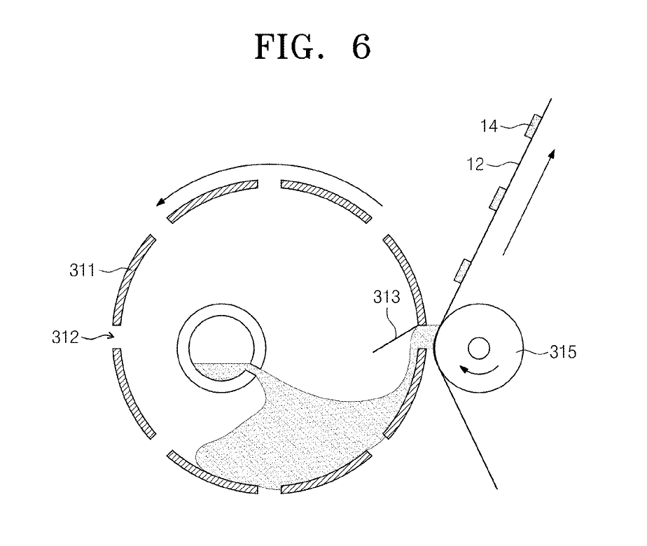

FIG. 1 is a flowchart illustrating a method for manufacturing a capacitor according to an embodiment of the present invention. FIG. 2 is a cross sectional view illustrating a capacitor according to an embodiment of the present invention. FIGS. 3A and 3B are plan views illustrating a separator according to an embodiment of the present invention. FIG. 4 is a cross-sectional view illustrating an ink-jet printing method according to an embodiment of the present invention. FIG. 5 is a perspective view illustrating a roll-to-roll printing method according to an embodiment of the present invention. FIG. 6 is a cross-sectional view illustrating a rotary type screen printing method according to an embodiment of the present invention.

Referring to FIGS. 1 and 2, a first electrode 12 is formed on a first substrate 10 in operation S10.

The first substrate 10 may be a metal-based substrate. For instance, the first substrate 10 may be a polymer substrate, a substrate coated with a metallic material such as aluminum, a metal substrate, a metal foil, or a substrate mixed with silicon and glass.

The first electrode 12 may include a carbon-based material. The first electrode 12 may include at least one selected from activated carbon, carbon nanotube, graphene, carbon aerogel, polyacrylonitrile (PAN), carbon nanofiber (CNF), activated carbon nanofiber (ACNF), vapor-grown carbon fiber (VGCF), and graphite. The carbon-based first electrode 12 may be a porous membrane having fine pores (not shown).

Referring to FIGS. 1 and 2, a separator 16 is formed on the first electrode 12 in operation S20

The separator 16 may include patterns 14. Referring to FIG. 3A, according to an embodiment, the patterns 14 may be arranged on the first electrode 12 such that the patterns 14 are separated from each other in a first direction and a second direction crossing the first direction. A separation space between the patterns 14 may be defined as a pore 15 of the separator 16. A portion of a top surface of the first electrode 12 may be exposed through the pore 15.

Referring to FIG. 3B, according to another embodiment, the patterns 14 may include first patterns 14a and second patterns 14b. The first patterns 14a may extend in the first direction and be arranged in the second direction crossing the first direction. The second patterns 14a may extend in the second direction and be arranged in the first direction such that the second patterns 14b cross the first patterns 14a. The first patterns 14a and the second patterns 14b may be formed at the same time. The first patterns 14a and the second patterns 14b may define the pores 15 of the separator 16. A portion of a top surface of the first electrode 12 may be exposed through the pore 15.

The patterns 14 may be formed by using an ink-jet printing, screen printing, reverse offset printing, doctor blade printing, roll-to-roll printing, spray printing, or gravure printing method. Specifically, the patterns 14 are formed by directly applying an ink to the first electrode 12 by using the printing method. The patterns 14 are directly formed on the first electrode 12, and thus may be selectively formed on a whole or part of a surface on the first electrode 12. Accordingly, by forming the patterns 14 only in a necessary area of the first electrode 12, passages for allowing ions to migrate may be secured as many as possible.

Referring to FIG. 4, the ink-jet printing method is a process in which an ink is injected into an inkjet head 111, and then a drop of the ink is ejected through a nozzle of the inkjet head 111 to thereby form the patterns 14 on the first electrode 12 at desired positions.

Referring to FIG. 5, the roll-to-roll printing method is a process in which an ink is provided through a squeegee 211, a mold 215 rolled around a roller 213 is coated with the ink, and the ink is then transferred onto the first electrode 12 to thereby form, on the first electrode 12, the patterns 14 having the shape of the mold 215.

Referring to FIG. 6, the rotary type screen printing method uses screen printing equipment. The rotary type screen printing equipment includes a circular rotary mask 311, a squeegee 313 installed inside of the rotary mask 311, and a backup roller 315 which transfer the first electrode 12. The rotary mask 311 includes opening patterns 312. In the rotary type screen printing method, the rotary mask 311 is filled with an ink, and, while the rotary mask 311 is rotating, the ink is imprinted on the first electrode 12 through the opening patterns 312 by an impression pressure of the squeegee 313, thereby forming the patterns 14 on the first electrode 12.

According to embodiments, the separator 16 is directly formed on the first electrode 12 by printing, materials are less wasted, a process such as develop and etching, which was necessary for photolithography, is not required, and a large-sized capacitor may be manufactured, thereby minimizing manufacturing costs for the capacitor. Furthermore, during formation of the separator 16, it is easy to control a pore structure (for example, porosity, pore size, and pore distribution) according to a print density and also easy to select a material having a predetermined interfacial energy with an electrolyte which will be formed in a subsequent process, thus making it possible to manufacture the capacitor with improved performance.

Referring to FIGS. 1 and 2, a second electrode 22 is formed on the separator 16 in operation S30

Specifically, the second electrode 22 may be formed directly on the separator 16. Alternatively, the second electrode 22 may be formed on a second substrate 20, and then the second substrate 20 may be disposed on the separator 16 to allow the second electrode 22 to come into contact with the separator 16.

The second substrate 20 may be a metal-based substrate. For instance, the second substrate 20 may be a polymer substrate, a substrate coated with a metallic material such as aluminum, a metal substrate, a metal foil, or a substrate mixed with silicon and glass.

The second electrode 22 may include a carbon-based material. The second electrode 22 may include at least selected from activated carbon, carbon nanotube, graphene, carbon aerogel, polyacrylonitrile (PAN), carbon nanofiber (CNF), activated carbon nanofiber (ACNF), vapor-grown carbon fiber (VGCF), and graphite. The carbon-based second electrode 22 may be a porous membrane having fine pores (not shown).

Referring to FIGS. 1 and 2, an electrolyte 18 is filled between the first electrode 12 and the second electrode 22 in operation S40

The electrolyte 18 may wholly or partially fill the fine pores of the first and second electrodes 12 and 22, and the pores 15 of the separator 16.

The electrolyte 18 may be an organic electrolyte solution including a non-lithium-salt such as TEABF₄ and TEMABF₄, or including at least one lithium salt selected from the group consisting of LiPF₆, LiBF₄, LiCLO₄, LiN(CF₃SO₂)₂, CF₃SO₃Li, LiC(SO₂CF₃)₃, LiAsF₆ and LiSbF₆, or a mixture thereof.

The solvent of the electrolyte 18 may be at least one of materials selected from the group consisting of ethylene carbonate, propylene carbonate, dimethyl carbonate, ethyl methyl carbonate, sulforane, and dimethoxy ethane, but is not limited thereto. The electrolyte 18 in which a solute and a solvent thereof are mixed has a high withstanding voltage and conductivity.

An order in a capacitor manufacturing process following the formation of the separator 16 is not limited to the description above.

Methods for manufacturing a capacitor according to an embodiment of the present invention include directly forming a separator on a first electrode. Since the separator is formed by printing, these methods prevent the waste of material, do not need a process such as developing and etching, which was necessary for photolithography, and enable a large-sized capacitor to be manufactured, thereby minimizing manufacturing costs for the capacitor.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for manufacturing a capacitor, the method comprising:
forming a first electrode on a first substrate;
forming a separator directly on a first electrode in contact with the first electrode;
forming a second electrode directly on the separator to come in contact with the separator, and then forming a second substrate on the second electrode; and
filling an electrolyte between the first electrode and the second electrode,
wherein the separator comprises patterns and pores defined by the patterns, and the patterns are formed by directly applying an ink to the first electrode through a printing process, and
wherein the patterns are arranged to be separated from each other in a first direction and a second direction crossing the first direction, and the patterns are spaced apart from each other without being in contact with each other.

2. The method of claim 1, wherein the printing process comprises ink-jet printing, screen printing, reverse offset printing, doctor blade printing, roll-to-roll printing, spray printing, or gravure printing.

3. (canceled)

4. (canceled)

5. (canceled)

6. The method of claim 1, wherein the patterns are selectively formed on a whole or part of a surface of the first electrode.

7. The method of claim 1, wherein the separator comprises cellulose, polyolefin, polyethylene, polypropylene, polyamide, polyethylene terephthalate (PET), or polytetrafluoroethylene (PTFE).

8. The method of claim 1, wherein the electrolyte fills a whole or part of the pores.

9. A capacitor, comprising:
a first electrode;
a separator formed directly on and in contact with the first electrode, the separator comprising patterns which are arranged on the first electrode to be separated from each other in a first direction and a second direction crossing the first direction, wherein the patterns are spaced apart from each other without being in contact with each other;
a second electrode disposed on the separator in contact with the separator; and
an electrolyte filled between the first electrode and the second electrode.

10. The capacitor of claim 9, wherein the patterns extend in the first direction and the second direction.

11. The capacitor of claim 9, wherein the separator further comprises pores defined by the patterns, and the electrolyte fills a whole or part of the pores.
